(19) United States
(12) Patent Application Publication
(10) Pub. No.: US 2025/0240649 A1
(43) Pub. Date: Jul. 24, 2025

(54) AN ADAPTIVE CHANGE ENGINE SYSTEM AND A METHOD THEREOF

(71) Applicant: JIO PLATFORMS LIMITED, Ahmedabad, Gujarat (IN)

(72) Inventors: Polsoni Chaitanya REDDY, Tellapur, Hyderabad, Telangana (IN); Ritesh KUMAR, Gaya, Bihar (IN); Aayush BHATNGAR, Navi Mumbai, Maharashtra (IN); Pradeep Kumar BHATNAGAR, Navi Mumbai, Maharashtra (IN)

(73) Assignee: JIO PLATFORMS LIMITED, Ahmedabad, Gujarat (IN)

(21) Appl. No.: 18/881,856

(22) PCT Filed: Oct. 30, 2023
(86) PCT No.: PCT/IB2023/060909

§ 371 Date: Jan. 7, 2025

(30) Foreign Application Priority Data
Oct. 31, 2022 (IN) 202221061991

(51) Int. Cl. H04W 24/02; H04L 41/0816

(52) U.S. Cl. CPC H04W 24/02; H04L 41/0816

(57) ABSTRACT

The present disclosure relates to a change engine system (104) and a method thereof for automatic interference mitigation in a network. The change engine system (104) receives a plurality of change requests. The system (106) determines interference network cell data from the received plurality of change requests. Further, the system (106) indexes and segments the determined interference network cell data across a plurality of states and a plurality of network elements and determines a change parameter of a plurality of change parameters. Also, the system (106) determines a command of a plurality of commands based on the determined change parameter and applies the command on the plurality of network elements to automatically mitigate the interference in the network.

### RESERVATION OF RIGHTS

A portion of the disclosure of this patent document contains material, which is subject to intellectual property rights such as, but are not limited to, copyright, design, trademark, Integrated Circuit (IC) layout design, and/or trade dress protection, belonging to Jio Platforms Limited (JPL) or its affiliates (hereinafter referred as owner). The owner has no objection to the facsimile reproduction by anyone of the patent document or the patent disclosure, as it appears in the Patent and Trademark Office patent files or records, but otherwise reserves all rights whatsoever. All rights to such intellectual property are fully reserved by the owner.

### TECHNICAL FIELD

The present disclosure relates to a field of wireless communication, and specifically to a change engine system and method for identifying interference network cell data in real-time and automatically mitigating the interference. More specifically, the present disclosure relates a highly scalable dynamic adaptive change engine for automatic interference mitigation.

### BACKGROUND

The following description of related art is intended to provide background information pertaining to the field of the disclosure. This section may include certain aspects of the art that may be related to various features of the present disclosure. However, it should be appreciated that this section be used only to enhance the understanding of the reader with respect to the present disclosure, and not as admissions of prior art.

In prevalent times, consumer adoption of user equipment (UE) such as cellular telephones, laptop computers, pagers, personal digital assistants, and the like, is increasing. These devices can be used in a wireless communication network for performing a variety of activities ranging from basic communications to conducting business transactions, managing entertainment media, and a host of other tasks. As sophistication of data applications is increasing tremendously, there is a marginal shift in communicating data over the air leading to operation of radio frequencies on a similar frequency, or range of frequencies resulting in interference with communications between the UEs and a network site.

To identify and determine level of interference occurrence in the network, as well as implementing mitigation actions, requires human intervention, and hence the human intervention is more time-consuming and error-prone.

There is, therefore, a need in the art for systems and methods that can mitigate interference, thereby reducing disruptions in communications in real-time.

### OBJECTS OF THE PRESENT DISCLOSURE

It is an object of the present disclosure to provide a change engine system and a method that identifies interference data in real-time and automatically mitigates the interference without human intervention.

It is an object of the present disclosure to provide a change engine system and a method that dynamically adapts to change required by a network and identifies victim cells facing interference to take corrective measures.

It is an object of the present disclosure to provide a change engine system and a method that analyzes interference data in real-time or near real-time, identifies aggressor cells, and applies tilt and power changes in real-time.

It is an object of the present disclosure to enhance the network performance and provide a superior user experience.

### SUMMARY

This section is provided to introduce certain objects and aspects of the present disclosure in a simplified form that are further described below in the detailed description. This summary is not intended to identify the key features or the scope of the claimed subject matter.

In an aspect, the present disclosure relates to a change engine system for automatic interference mitigation in a network. The change engine system includes one or more processors and a memory operatively coupled to the one or more processors. The memory includes processor-executable instructions, which on execution, cause the one or more processors to receive a plurality of change requests from. The one or more processors determine interference network cell data from the received plurality of change requests from a plurality of sources. Further, the one or more processors index and segment the determined interference network cell data across a plurality of states and a plurality of network elements and determine a change parameter of a plurality of change parameters based on the indexed and segmented interference network cell data. Also, the one or more processors determine a command of a plurality of commands based on the determined change parameter and apply the command on the plurality of network elements to automatically mitigate the interference in the network.

In an embodiment, the plurality of sources may include at least one of a Remote Electrical Tilt (RET), a Topographic Interference Mitigation (TIM), and an Automatic Telecommunications Operator (ATO).

In an embodiment, the plurality of change requests may include information corresponding to at least one of a plurality of cells, interference corresponding to the plurality of cells, and changes corresponding to the interference.

In an embodiment, the command may correspond to a change in a configuration of an antenna tilt and a power attenuation.

In an embodiment, the one or more processors may determine the at least one command by being configured to determine a plurality of change commands based on the determined plurality of change parameters. Also, the one or more processors may map each of the plurality of change commands with each of the plurality of change parameters. The mapped information may be stored in a database associated with the change engine system. Further, the one or more processors may determine the command based on the mapping.

In an embodiment, the plurality of commands may be based on at least one of a plurality of network element types, a plurality of software versions, and options related to logical change.

In an embodiment, the one or more processors may automatically detect a failure of the command applied on the plurality of network elements in the network. Also, the one or more processors may segregate the failed command from successful commands based on the detection. Further, the one or more processors may automatically reapply the failed command on the corresponding plurality of network elements.

In an embodiment, the one or more processors may determine whether a number of reapplying of the failed command on the corresponding plurality of network elements exceeds a predefined threshold. Also, the one or more processors may ignore the reapplying of the at least one failed command on the plurality of network elements, in response to a positive determination. Further, the one or more processors may adjust the failed command to be reapplied on the plurality of network elements.

In an embodiment, the one or more processors may generate, in real time, a report comprising at least one of information of the at least one failed command and information of the successful commands.

In an embodiment, the one or more processors may predict the interference in the network based on the determined interference network cell data.

In another aspect, the present disclosure relates to a method for automatic interference mitigation in a network. The method includes receiving, by one or more processors associated with a change engine system, a plurality of change requests from a plurality of sources, determining, by the one or more processors, interference network cell data from the received plurality of change requests, indexing and segmenting, by the one or more processors, the determined interference network cell data across at least one of: a plurality of states and a plurality of network elements, determining, by the one or more processors, a change parameter of a plurality of change parameters based on the indexed and segmented interference network cell data, determining, by the one or more processors, a command of a plurality of commands based on the determined change parameter, and applying, by the one or more processors, the command on the plurality of network elements to automatically mitigate the interference in the network.

In an embodiment, the method may include determining, by the one or more processors, a plurality of change commands based on the determined plurality of change parameters, mapping, by the one or more processors, each change command of the plurality of change commands with each of the plurality of change parameters, wherein the mapped information may be stored in a database associated with the change engine system, and determining, by the one or more processors, the at least one command based on the mapping.

In an embodiment, the method may include automatically detecting, by the one or more processors, a failure of the command applied on the plurality of network elements in the network, segregating, by the one or more processors, the failed command from successful commands based on the detection, and automatically reapplying, by the one or more processors, the failed command on the corresponding plurality of network elements.

In an embodiment, the method may include determining, by the one or more processors, whether a number of reapplying of the failed command on the corresponding plurality of network elements exceeds a predefined threshold, in response to a positive determination, ignoring, by the one or more processors, the reapplying of the failed command on the plurality of network elements, and in response to a negative determination, adjusting, by the one or more processors, the failed command to be reapplied on the plurality of network elements.

In an embodiment, the method may include generating, in real time, by the one or more processors, a report comprising at least one of information of the at least one failed command and information of the successful commands.

In another aspect, the present disclosure relates to a non-transitory computer-readable medium comprising processor-executable instructions that cause a processor to receive a plurality of change requests from, determine interference network cell data from the received plurality of change requests, index and segment the determined interference network cell data across at least one of a plurality of states and a plurality of network elements, determine a change parameter of a plurality of change parameters based on the indexed and segmented interference network cell data, determine the command of a plurality of commands based on the determined change parameter, and apply the command on the plurality of network elements to automatically mitigate the interference in the network.

### BRIEF DESCRIPTION OF THE DRAWINGS

In the figures, similar components and/or features may have the same reference label. Further, various components of the same type may be distinguished by following the reference label with a second label that distinguishes among the similar components. If only the first reference label is used in the specification, the description is applicable to any one of the similar components having the same first reference label irrespective of the second reference label.

The diagrams are for illustration only, which thus is not a limitation of the present disclosure, and wherein:

FIG. 1 illustrates an architecture (100) of a highly scalable dynamic adaptive change engine system (104), in accordance with an embodiment of the present disclosure.

FIG. 2 illustrates an exemplary block diagram (200) of the change engine system (104), in accordance with an embodiment of the present disclosure.

FIG. 3 illustrates an exemplary flowchart of a method (300) for implementing highly scalable dynamic adaptive change engine system, in accordance with an embodiment of the present disclosure.

FIG. 4 illustrates exemplary tables (400) for different types of available databases, in accordance with an embodiment of the disclosure.

FIGS. 5A-5F illustrate exemplary representations (500, 510, 520, 530, 540, 550) for creation, generation, and presentation of a report, in accordance with embodiments of the disclosure.

FIG. 6 illustrates an exemplary computer system (600) in which or with which embodiments of the present disclosure may be implemented.

The foregoing shall be more apparent from the following more detailed description of the disclosure.

### DETAILED DESCRIPTION

In the following description, for the purposes of explanation, various specific details are set forth in order to provide a thorough understanding of embodiments of the present disclosure. It will be apparent, however, that embodiments of the present disclosure may be practiced without these specific details. Several features described hereafter can each be used independently of one another or with any combination of other features. An individual feature may not address all of the problems discussed above or might address only some of the problems discussed above. Some of the problems discussed above might not be fully addressed by any of the features described herein.

The ensuing description provides exemplary embodiments only, and is not intended to limit the scope, applicability, or configuration of the disclosure. Rather, the ensuing description of the exemplary embodiments will provide those skilled in the art with an enabling description for implementing an exemplary embodiment. It should be understood that various changes may be made in the function and arrangement of elements without departing from the spirit and scope of the disclosure as set forth.

Specific details are given in the following description to provide a thorough understanding of the embodiments. However, it will be understood by one of ordinary skill in the art that the embodiments may be practiced without these specific details. For example, circuits, systems, networks, processes, and other components may be shown as components in block diagram form in order not to obscure the embodiments in unnecessary detail. In other instances, well-known circuits, processes, algorithms, structures, and techniques may be shown without unnecessary detail in order to avoid obscuring the embodiments.

Also, it is noted that individual embodiments may be described as a process which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed but could have additional steps not included in a figure. A process may correspond to a method, a function, a procedure, a subroutine, a subprogram, etc. When a process corresponds to a function, its termination can correspond to a return of the function to the calling function or the main function.

The word “exemplary” and/or “demonstrative” is used herein to mean serving as an example, instance, or illustration. For the avoidance of doubt, the subject matter disclosed herein is not limited by such examples. In addition, any aspect or design described herein as “exemplary” and/or “demonstrative” is not necessarily to be construed as preferred or advantageous over other aspects or designs, nor is it meant to preclude equivalent exemplary structures and techniques known to those of ordinary skill in the art. Furthermore, to the extent that the terms “includes,” “has,” “contains,” and other similar words are used in either the detailed description or the claims, such terms are intended to be inclusive in a manner similar to the term “comprising” as an open transition word without precluding any additional or other elements.

Reference throughout this specification to “one embodiment” or “an embodiment” or “an instance” or “one instance” means that a particular feature, structure, or characteristic described in connection with the embodiment is included in at least one embodiment of the present disclosure. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

The terminology used herein is for the purpose of describing particular embodiments only and is not intended to be limiting to the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items.

The terms “work order” and “change request” may be interchangeably used throughout the disclosure.

The present disclosure provides a system and a method for identifying interference network cell data present in a network in real-time and automatically mitigating the interference by using a highly scalable dynamic adaptive change engine system. The change engine system is a custom adaptation of dynamic adaptive programming, which configures changes for radio access networks managed by operational support systems.

The change engine system has varied applications including dynamically changing network configuration through an adaptive mechanism. One of the change engine's real-world application use cases is its ability to dynamically decrease the interference caused by macros to other radio network elements which are geographically separated by varying distances by executing changes in antenna tilt and power attenuation. These changes are applied at differing political geographic levels like inter-state or at different element management levels. The disclosed change engine system is self-learning and adaptive and resolves the interference caused by different macros, Evolved Node B (eNodeB), etc. across different geographies with zero or near-zero human interference.

The disclosed system and method index the inter-state interference network cell data and segments the network cell data across different (a) telecom redefined states in real-time, and (b) element management systems of differing vendors in real-time. Further, required changes are applied across the network on different network elements based on work orders. In addition, the changes are mapped to relevant change commands, where (a) the change commands are selected from a database catalogue of a huge number of commands, (b) commands are based on different (i) network element types (eNB, Outdoor Small Cell/Indoor Small Cell (ODSC/IDSC)), (ii) multiple software versions (v7.00, v9.0.3, v9.0.5), and (iii) logical change related options.

The disclosed system and method facilitate the extraction of executable commands to be applied, based on mapping changes and change commands. The change engine system selects various types of commands, such as tilt changes and power attenuation. Furthermore, the selected commands are applied to the network elements to enable interference mitigation across the network. The change engine system has a built-in adaptive mechanism to automatically detect change failures.

The disclosed system and method identify and segregate changes that have failed and automatically re-attempt the required changes on the failed cells. The required changes are applied a specified number of times until either (a) the changes are applied or (b) the system determines that the changes cannot be applied at that instance of time. All the required changes are applied in real-time or near real-time to decrease interference on network elements by around 60% leading to increasing performance of the network.

In an embodiment, the change engine system executes in a never-ending loop based on the interference cells and associated changes it keeps receiving in a contiguous fashion until the network interference has completely abated or sharing of the interference cells details is stopped.

In another embodiment, the cell(s) on which the changes have been successfully executed, and the ones on which the changes are not successfully executed may be extracted through reports. The reports may be visualized on coverage maps in real-time. Based on manual analysis through the reports and visualizations, configuration experts may tweak configuration parameters through administration modules. When the modules are applied, dynamic changes are triggered on the network, and re-synchronized the updated configuration parameters based on dynamic changes.

Execution of the change engine system is highly scalable and is optimized by the use of a parallel execution mechanism that caters to executing millions of commands in a shorter time span. The system performs (a) processing of input request work orders, (b) segregation of cells in the input request work orders into work orders at either state-level or at element management server level, (c) mapping of unique commands per execution based on associated change commands, (d) disbursement of the commands, (e) extraction of the command executions status of the millions of network elements in parallel in real-time, (f) collation of responses of all the node's execution status, (g) analysis of the response, classifies and groups them in respective success and failure batches. Further, the system collates the cells to the original work order grouping and responds back to a request initiator in a few seconds. However, when the change is executed on third-party vendor systems, there is an addition of an overhead of a few minutes which percolates to an end-to-end time taken. Currently, the system caters to three different types of modules with a potential to cater to any number of modules that may execute changes on the network in real-time or near real-time. The realization of the logic is done using multiple micro-services such as streaming data pipelines. As the network scales simultaneously, multiple instances of the micro-services are spawned after server-managed network resource usage threshold limits are crossed. Similarly, multiple spark jobs may be spawned for zonal or circle levels to cater to ever-increasing change engine executions. As may be appreciated, scale here is only constrained by availability of hardware.

Dynamic uncertainty is a mismatch between “expected system outcome” and “real world system outcomes” including issues like ‘network outage,’ ‘node connectivity,’ and ‘system or server-blade failures’ which are outside control of the execution system but inadvertently impact overall system performance. This uncertainty is addressed by taking an erroneous output as input, which is further fed back into the change engine system in a built-in loopback mechanism. Through this loopback mechanism, failed system options are put back into the change engine system to re-initialize and trigger the changes that need to be applied once again in a dynamic fashion until either all failed systemic changes are corrected or the system deems that any further correction is not possible or is far too costly to execute and exits the cycle of analysis, learn, adapt and eventually triggers a loopback cycle. This is a custom partial variation of a back propagation method.

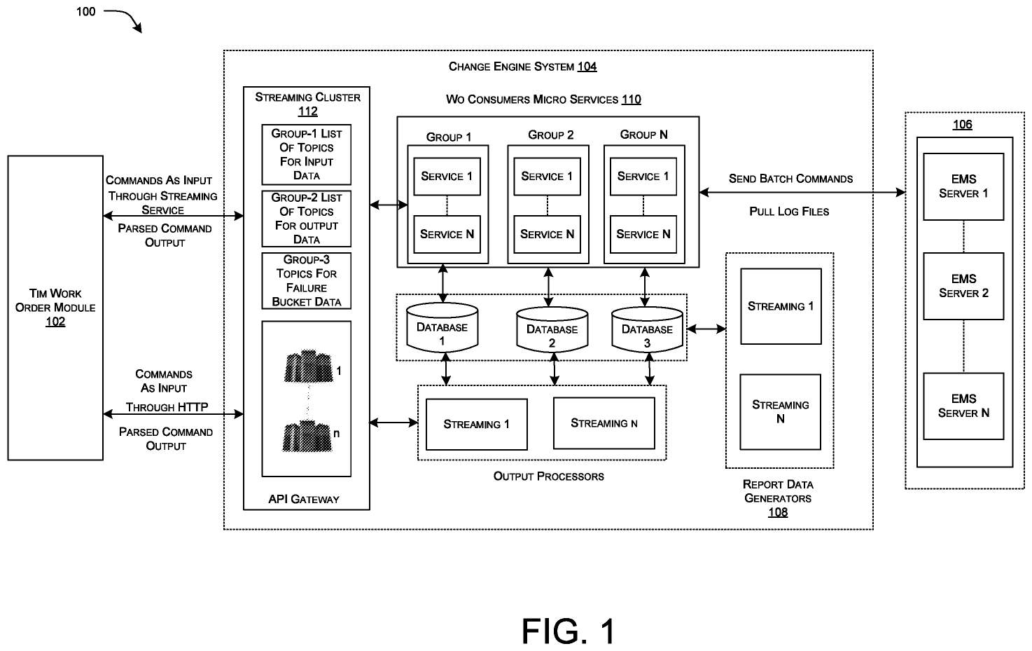

Various embodiments of the present disclosure will be explained in detail with reference to FIGS. 1-6.

FIG. 1 illustrates an example architecture (100) of a highly scalable dynamic adaptive change engine system (104), in accordance with an embodiment of the present disclosure.

The change engine system (104) may be used in one of the scenarios such as for Topographic Interference Mitigation (TIM), Element Management System (EMS) executions, Input to Report Engine and backend support to Graphical User Interface (GUI) through Representational State Transfer (REST/RESTful) Application Programming Interface (API) calls.

A TIM work order module (102) includes identifying cells on which configuration changes need to be applied in real-time or near real-time.

The adaptive change engine system (104) may include a plurality of consumer micro services (110) that interact with the TIM work order module (102) through RESTful APIs and/or available streaming services (112). Data exchange format between the TIM work order module (102) and the adaptive change engine system (104) may be done through different file types (Common Separated Value (CSV), JavaScript Object Notation (JSON), or the like). Upon receiving a work order, the adaptive change engine system (104) performs its validations and regroups the data based on its internal criteria such as using a Telecom Regulatory Authority specified states or vendor-specific EMS. This re-grouped work orders with different change commands and respectively mapped commands like tilt and power attenuation is applied on the network through EMS server(s) (106). The EMS server(s) (106) executes and sends back the execution responses and more detailed information to the adaptive change engine system (104) for further analysis.

The adaptive change engine system (104) parses output received along man-machine language data and extracts successful and failure cell details based on generic in-built logical criteria. The extracted information is sent to the TIM work order module (102) and extracted information is used to create reports.

A report data generator(s) (108) creates reports at multiple levels for operations and management personnel. This includes auto-generated reports as well as on-demand reports. These reports are created at multiple levels including change engine system (104). Apart from status reports, analysis reports are also produced which are used to analyze network data, which aids in the modification of parameters through configuration files.

A Graphical User Interface (GUI) helps in a visual representation of the eNodeB across different viewports. Each viewport can range from around 50 square meters to a wide map. Through this visual representation, an individual victim cell as well as complete groups of cells may be identified. The cells listed in the visual representation and their associated information may be extracted from different databases. Further, a database 1 stores cell-level information, a database 2 stores configuration information, and a database 3 stores geographical data.

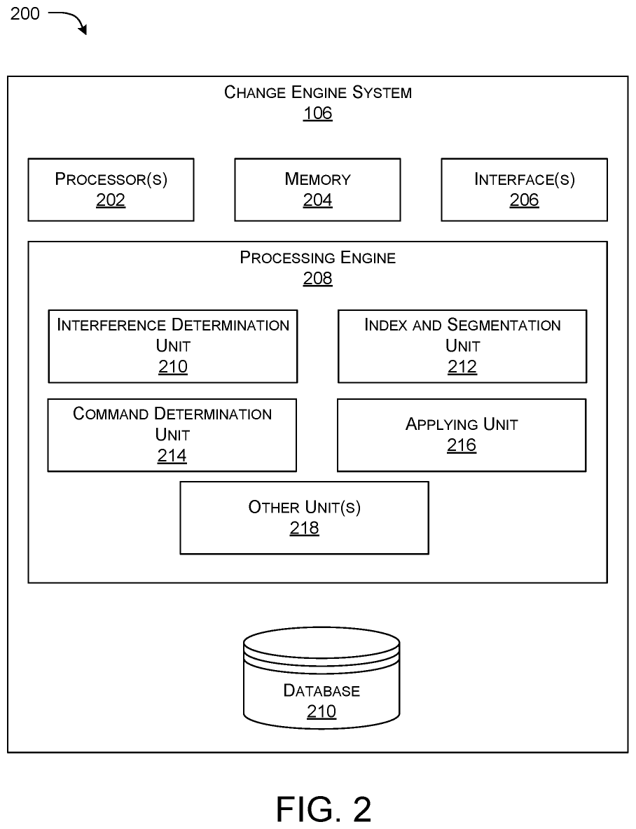

FIG. 2 illustrates an exemplary block diagram (200) of the change engine system (104), in accordance with an embodiment of the present disclosure.

The change engine system (104) may include a processor(s) (202), a memory (204), an interface (206), a processing engine (208), and a database (210). The memory (204) is operatively coupled to the one or more processors (202). The one or more processors (202) may be implemented as one or more microprocessors, microcomputers, microcontrollers, digital signal processors, central processing units, logic circuitries, and/or any devices that manipulate data based on operational instructions. Among other capabilities, the one or more processor(s) (202) may be configured to fetch and execute computer-readable instructions stored in the memory (204) of the change engine system (104). The memory (204) may store one or more computer-readable instructions or routines, which may be fetched and executed to create or share the data units over a network service. The memory (204) may include any non-transitory storage device including, for example, volatile memory such as Random-Access Memory (RAM), or non-volatile memory such as Erasable Programmable Read-Only Memory (EPROM), flash memory, and the like.

In an embodiment, the change engine system (104) may also include an interface(s) (206). The interface(s) (206) may comprise a variety of interfaces, for example, a variety of interfaces, for example, interfaces for data input and output devices, referred to as I/O devices, storage devices, and the like. The interface(s) (206) may facilitate communication of the change engine system (104) with various devices coupled to it. The interface(s) (206) may also provide a communication pathway for one or more components of the change engine system (104). Examples of such components include, but are not limited to, processing engine (208) and database (210).

In an embodiment, the processing engine (208) may be implemented as a combination of hardware and programming (for example, programmable instructions) to implement one or more functionalities of the processing engine (208). In the examples described herein, such combinations of hardware and programming may be implemented in several different ways. For example, the programming for the processing engine (208) may be processor-executable instructions stored on a non-transitory machine-readable storage medium and the hardware for one or more processors (202) may comprise a processing resource (for example, one or more processors), to execute such instructions. In the present examples, the machine-readable storage medium may store instructions that, when executed by the processing resource, implement the processing engine (208). In such examples, the change engine system (104) may comprise the machine-readable storage medium storing the instructions and the processing resource to execute the instructions, or the machine-readable storage medium may be separate but accessible to the change engine system (104) and the processing resource. In other examples, the processing engine (208) may be implemented by an electronic circuitry.

The processing engine (208) may include an interference determination unit (210), an index and segmentation unit (212), a command determination unit (214), and an applying unit (216). The processing engine (208) receives a plurality of change requests from. multiple sources, where the sources may be, but not limited to, Remote Electrical Tilt (RET), Topographic Interference Mitigation (TIM), Automatic Telecommunications Operator (ATO), and the like. The interference determination unit (210) may determine the interference network cell data from the received plurality of change requests. The index and segmentation unit (212) may index and segment the interference network cell data across the plurality of states and the plurality of network elements. The command determination unit (214) may determine the change parameter based on the indexed and segmented interference network cell data and may be configured to determine change commands based on the determined change parameter, For example, the commands are executed on networks and/or network elements to change the required parameters, that is, the parameters and their values are pre-existing, but those values are not correct and need to be modified, and these modifications of parameter values are realized by the change-commands. Also, the command determination unit (214) may map each change command with each change parameter and send the mapping information to the database (210). The database (210) may store the mapping information between the change command and the change parameter. Further, the command determination unit (214) may determine the command based on the mapping information between the change command and the change parameter, where the command is based on the type of network, the software versions, and the options related to logical change. Once the command determination unit (214) determines the command, the applying unit (216) may apply the command on the network elements to automatically mitigate the interference in the network. While applying the command on the network elements, the applying unit (216) automatically detects a failure of the command applied on the network elements and segregates the failed commands from successful commands. Once the failed commands are segregated, the applying unit (216) may automatically reapply the failed commands on the corresponding network elements.

Also, the applying unit (216) may have a predefined threshold range to limit the reapplying of failed commands on the network elements. For example, the predefined threshold may involve reapplying the failed commands on the network elements up to 5 times. When the reapplying of the failed command exceeds the limit of 5 times, the applying unit (216) ignores further attempts to apply the command on the network elements. In an embodiment, when the predefined threshold is below the limit, the applying unit (216) adjusts the failed command to reapply on the network elements. In an embodiment, the failed commands are adjusted manually to be reapplied on the network elements. The change engine system (104) collects information of the failed commands and the successful commands to generate the report. The other unit(s) (218) can implement functionalities that supplement applications/functions performed by the processing engine (208).

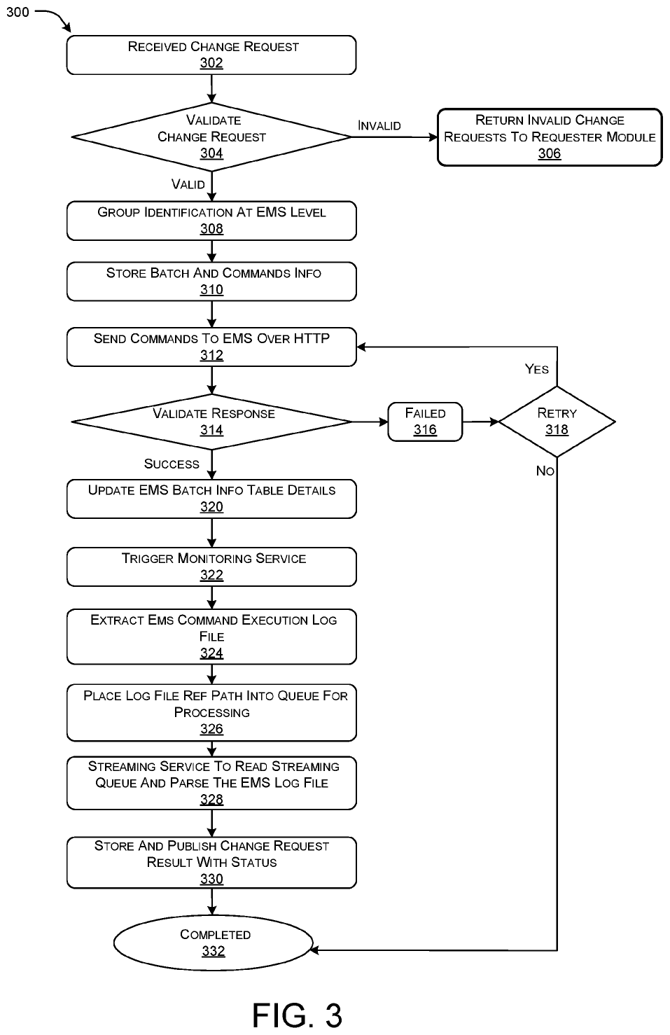

FIG. 3 illustrates an exemplary flowchart of a method (300) for implementing the highly scalable dynamic adaptive change engine system (104), in accordance with an embodiment of the disclosure.

At step 302, the method may include receiving the change request. The change request is validated at 304. The validation is performed based on identifying the vendors, where each vendor has a different node type like eNodeB, gNodeB, etc. Each node type has different versions and each version has different parameters. Each parameter has a different data type. Hence, the validation is performed based on determining all factors like vendor, node type, version, data type, etc. If invalid, the invalid change request is sent back to a requester module, at 306. If the change request is validated, then at 308, group identification is performed at the EMS level. Further, at 310, batch and command information are stored. The command information is sent to EMS over, for example, Hypertext Transfer Protocol (HTTP), at 312. A check for validation of the response is performed at 314, and if the validation fails at 316, then a retry attempt is provided at 318. If the retry attempt is availed, then the flow is passed to 312.

However, if the response is validated, then EMS batch information table details are updated at 320. Further, a monitoring service is triggered at 322, and the EMS command execution log file is extracted at 324. At 326, a log file ref path is placed into a queue for processing. Next, at 328, a streaming service is executed to read the streaming queue and parse the EMS log file. Finally, at 330, a change request result is stored and published with status and marked as completed at 332. Also, if the retry attempt at 318 is not availed, the change request is marked as completed at 332.

In an embodiment, there is disclosed a mathematical representation of a highly scalable change engine for dynamic command execution, in accordance with an embodiment of the disclosure.

### I. Command Processing

1. Multiple Work Order and Sub Work Orders per Time interval
2. In each Work Order (WO) and Sub WO
   a. Cell {ex: Aggressors}details in each WO
   b. Change command information against each cell of the WO.

### II. Mathematical Representation of Dynamic Command Execution in Change Engine

N number of Work Orders are generated for every Time interval=WO_{{1 . . . N}} eq. (1)

M number of Aggressors exist in each WO=A_{{1 . . . M}} eq. (2)

In every time interval the num of WO and associated Aggressors are=WO_{{1 . . . N}}*A_{{1 . . . M}} eq. (3)

The WOs and their Aggressors are processed every 30 mins i.e., Time Intervals of 0 hours−23:30 hours=T_{{1 . . . 24×2}} eq. (4)

Number of Aggressors processed every day=T_{{1 . . . 24×2}}*WO_{{1 . . . N}}*A_{{1 . . . M}} eq. (5)

Overall number of aggressors processed is ΣT_{{1 . . . 24×2}}*WO_{{1 . . . N}}*A_{{1 . . . M}} eq. (6)
T_{{1 . . . 24}}: Triggering of tilt changes happens once every 30 min's, i.e., 24 times in a day.
WO_{{1 . . . N}}: N number of Work Orders that are executed during that time interval
A_{{1 . . . M}}: M number of aggressors on which the tilt is changed during that time interval
   Reverse Tilts to be applied on Aggressors in a day=

$${\sum }_{( P * 2 )}^{24} W 0 \{ 1 … N \} * A \{ 1 … M \}$$

*(Above is a representation of T_{{(P*2) . . . 24}}*WO_{{1 . . . N}}*A_{{1 . . . M}})
T_{{(P*2) . . . 24}}: Triggering of reverse tilt changes happens once every 30 mins after “P” hours of triggering the initial number of aggressors, i.e. {24−Pₕₒᵤᵣₛ*21 times in a day.
WO_{{1 . . . N}}: N number of Work Orders that are executed during that time interval
A_{{1 . . . M}}: M number of aggressors on which the tilt is changed during that time interval
   After collating the WOs, each WO is broken up into Sub-WO based on association of cells for each Element Management System (EMS}:

$${\sum }_{{x}^{″}}^{1 … {x}^{′}} T [ W O \{ 1 … N \} * {\sum }_{m}^{1 … {m}^{′}} EMS ] \\ {\sum }_{{x}^{″}}^{1 … {x}^{′}} T [ W O \{ 1 … N \} * {\sum }_{m}^{1 … {m}^{′}} LSMS ]$$

In a day, the number of intervals is {24−(P*2)}=x′*x″
Each WO is broken up into multiple sub-WOs each one at a Label Switching Multipath Routing (LSMR) level

i.e., Σ_{m″}^{1 . . . m′}EMS=WOₓ*A_{{1 . . . M}} eq. (7)
where M=m′*m″

A functional example for a highly scalable change engine for dynamic command execution is discussed below:
Example M=1000 aggressors
WO x=Only ‘1’ WO exists at that interval of time
Let 1000 aggressors belong to 10 LSMR's. It is assumed there are equal number of aggressors associated with each LSMR i.e., there 100 aggressors per LSMR (1000/10)
If 1000 aggressors belong to 3 LSMR's. It is assumed:
   1^{st} LSMR has 500 aggressors
   2^{nd} LSMR has 300 aggressors
   3^{rd} LSMR has 200 aggressors

$${\sum }_{3}^{1 ... 200} LMSR = 500 + 300 + 200$$

ΣLSMR_{{n . . . N}}^{{1 . . . n}}
   Next, a number of commands are associated that need to be executed for each aggressor based on its associated change command. This is done by:

Identifying the command(s) associated with change command(s) R₁=(software version)∩(change commands in DB) eq. (8)
Extract R1 in a DB of multiple change commands per software version
Change command provides details on how to execute the command(s) i.e., “in parallel”, “in sequence”, “in sequence with delay between command x and command y” etc.
The change command has multiple commands=R_{cmds}
   Multiple change commands exist in the database. Each of the change command is associated with a different type of function (e.g., Tilt Change, Attenuation, etc.).
   The number of commands executed in a day in the change engine is represented as:

$${R}_{Cmds} * [ {\sum }_{{x}^{″}}^{1 … {x}^{′}} T \{ W O \{ 1 … N \} * {\sum }_{m}^{1 … {m}^{′}} LSMS \} ]$$

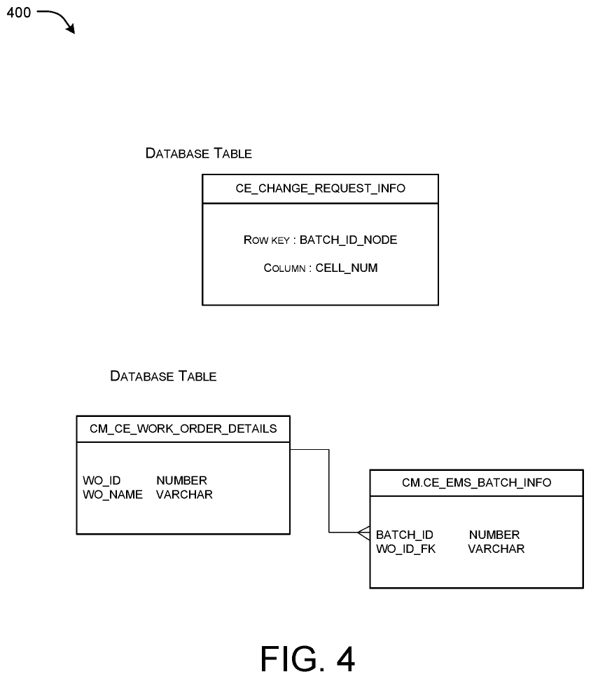

FIG. 4 illustrates exemplary tables (400) for different types of available databases, in accordance with an embodiment of the disclosure.

As an example, the database maintains change information requests and work orders, each associated with unique identifiers. The batch of EMS identifications is determined by the work orders, which internally use their own unique identifiers.

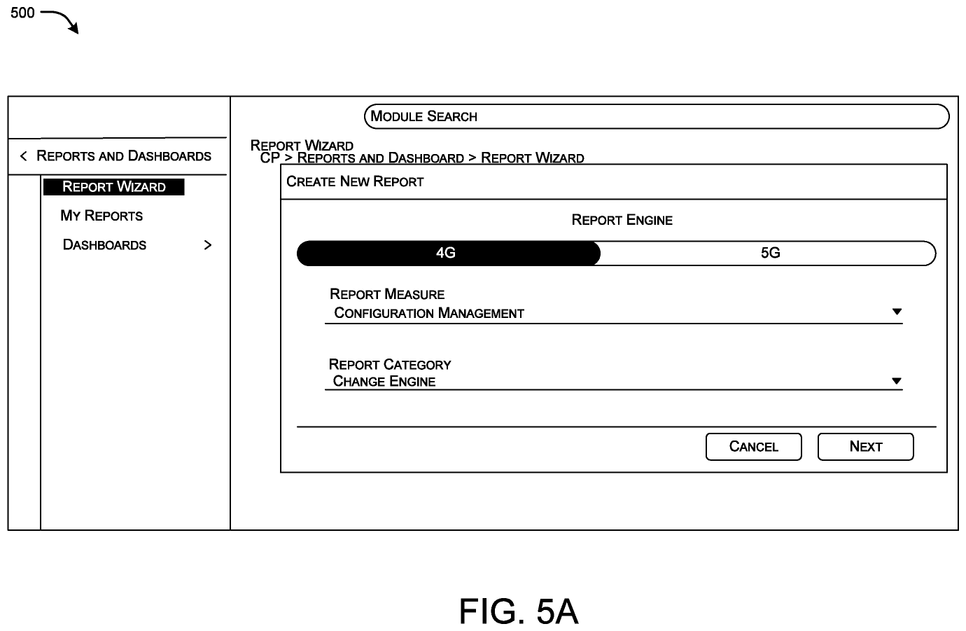

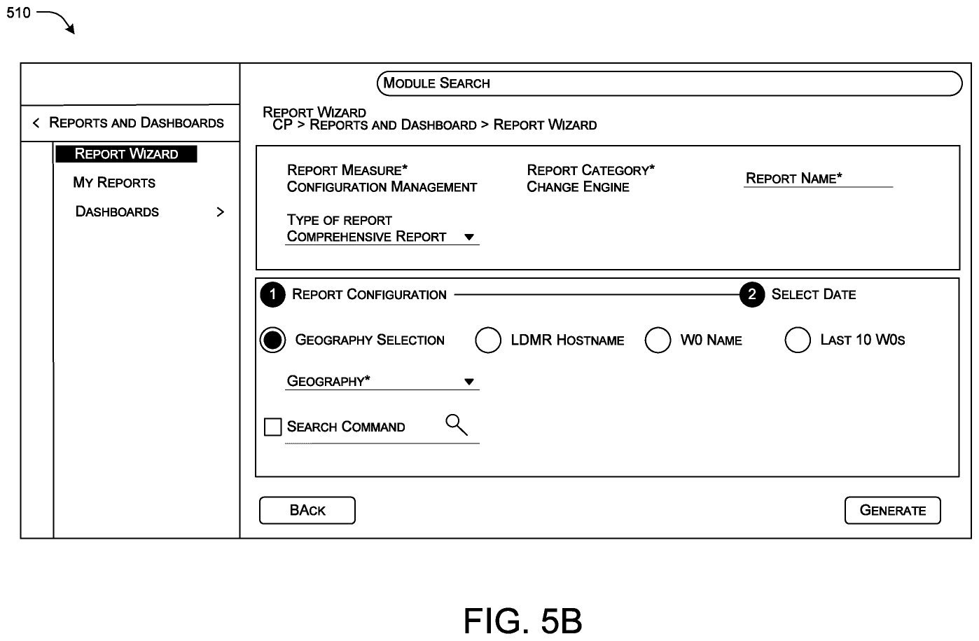

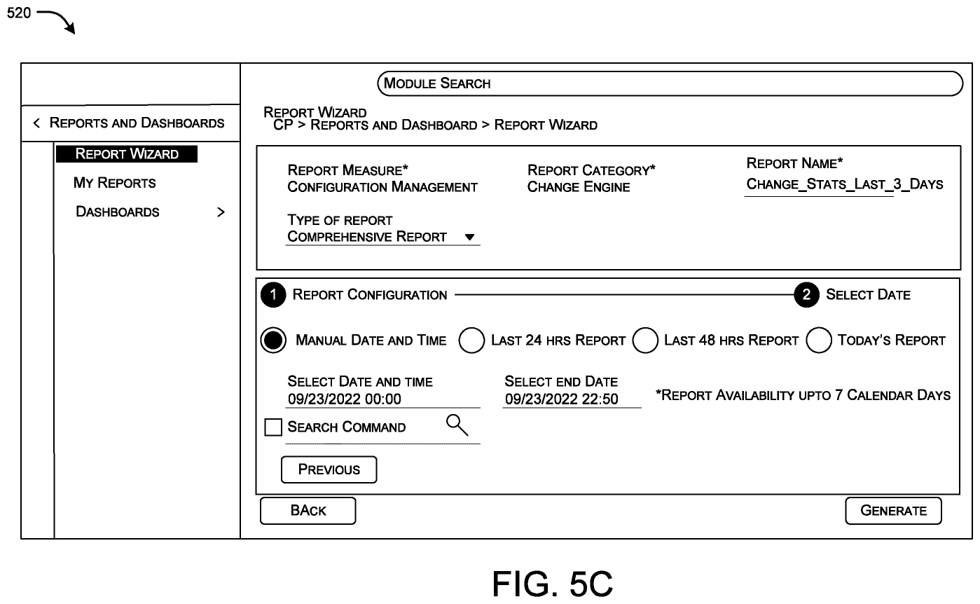

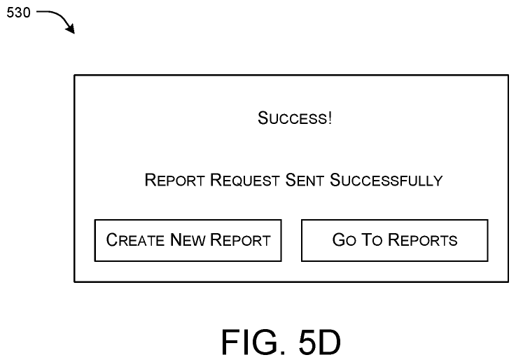

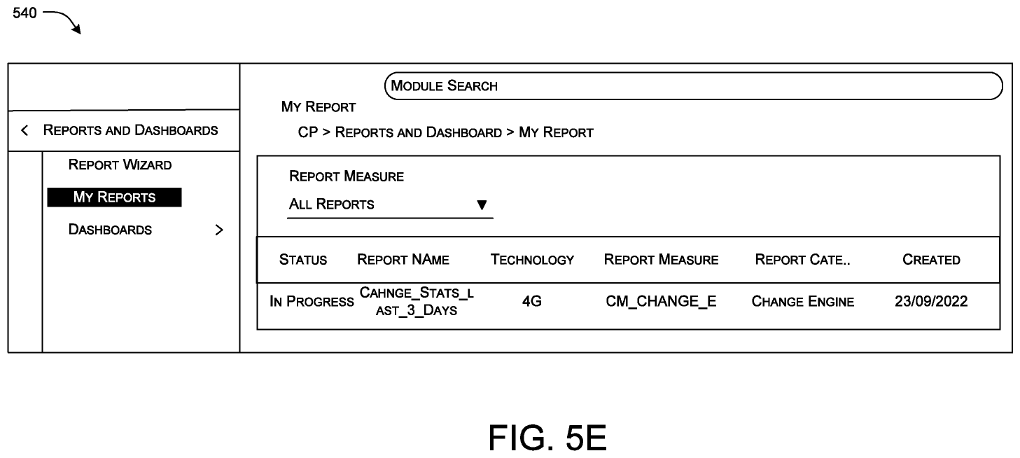

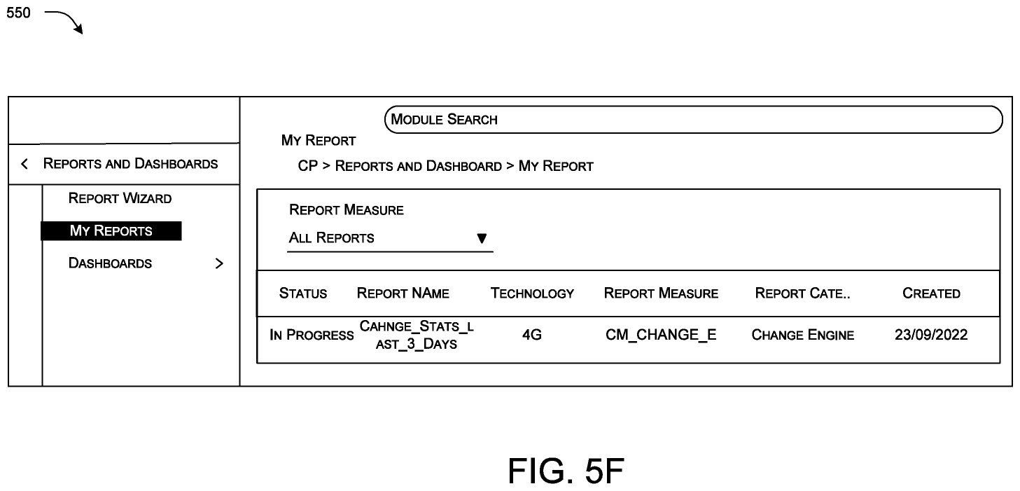

FIGS. 5A-5F illustrate exemplary screenshots for the creation, generation, and presentation of the report, in accordance with an embodiment of the disclosure. Report preparation is a backend functionality whose post-processed results may be extracted in the form of results and those results may be downloaded and viewed. Steps for the creation of the report are discussed with respect to FIGS. 5A-5F.

FIG. 5A illustrates, at 500, creation of a new Change Engine report which is part of configuration management. FIG. 5B illustrates, at 510, selection of specific geography with respect to changes that are to be performed. FIG. 5C illustrates, at 520, selection of changes with respect to time interval/duration (hours, days). FIG. 5D illustrates, at 530, a report generation triggering status i.e., success, or failure. FIG. 5E illustrates, at 540, current statuses i.e. in-progress status of report generation. FIG. 5F illustrates, at 550, a completed status of report generation. By way of an example, the generated report may be extracted and viewed in a particular format, for example, PDF, excel, word, etc.

Therefore, the disclosed system and method enables identification of aggressors in real-time or near real-time through interference levels, geographic distance, confidence level, and victim cell count. The disclosed system and method facilitates the application of tilt changes through upper side lobe suppression (USLS) logic and power attenuation changes, monitoring data, and re-applying new logic based on TIM data. For example, USLS logic is to identify a tilt for respective antenna model, considering three powers such as P1—Main lobe power below horizon, P2—Main lobe power above horizon, P3—Total power of all the upper side lobes excluding main lobe, and P2+P3 may be the total power radiating above the horizon. Considering the analysis of the total power (P2+P3) radiating above the horizon and the main lobe power below horizon (P1) of the antenna at different electrical tilts, the electrical tilt value of the antenna is determined at which the power radiating above the horizon is minimum compared to the main lobe power below horizon.

Further, the disclosed system and method enables the use of available interference data (i.e., previous day) to predict the duration of interference today and apply for that duration. In addition, future interference cells are predicted based on past interference patterns. Furthermore, the disclosed system and method enables administrative tools to dynamically change configuration and apply the same on algorithm rule applications to change predictions dynamically.

The disclosed system and method provides a highly scalable dynamic adaptive change engine for automatic interference mitigation, where changes are executed dynamically with no human intervention. This is achieved by (a) fetching interference network cell data from different work orders, (b) streaming interference network cell data through streaming listeners, (c) indexing inter-state interference network data, (d) segmenting interference network data across different states, and element management systems in real-time, and (e) applying associated changes across the network on different network elements.

The changes are converted to executable commands dynamically based on change commands associated with the changes that need to be applied. The change command may be selected from a database which catalogues a huge number of commands based on options such as different network element types, multiple software versions, and varying logical change-related options.

The change engine system (104) selects varying types of commands for tilt changes and power attenuation modifications to address interference mitigation based on different element types, software versions, and selection logic, so that shortlisted changes may be applied on the network elements to enable interference mitigation across the network.

The change engine system (104) not only has an in-built adaptive mechanism to auto-detect change failures but also has the ability to identify and segregate changes that have failed. The change engine automatically re-attempts required changes on the failed cells a specified number of times until either the changes are applied or the system determines that the changes cannot be applied at that instance of time. All these changes are applied in real-time and near real-time to decrease the interference on the network elements, thereby increasing the network performance. The change engine system (104) executes in a never-ending loop based on the interference cells and associated changes it keeps receiving in a contiguous fashion until the network interference has completely abated or the sharing of the interference cells details is stopped.

As may be appreciated, the disclosed system and method facilitate to reduce interference on tens of thousands of cells resulting in better network performance. On a daily basis, the proposed method enables to identification of interference and mitigation on around 5 lakhs+ cells in the complete network for around 3+ months in a year. This results in supporting more users on the network than when the interference existed.

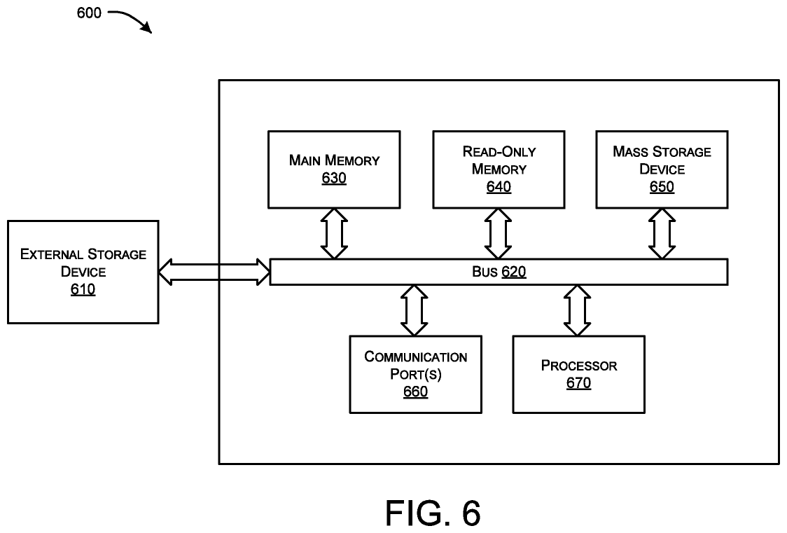

FIG. 6 illustrates an exemplary computer system (600) in which or with which embodiments of the present invention can be utilized in accordance with embodiments of the present disclosure.

As shown in FIG. 6, the computer system (600) may include an external storage device (610), a bus (620), a main memory (630), a read only memory (640), a mass storage device (650), a communication port (660), and a processor (670).

A person skilled in the art will appreciate that the computer system (600) may include more than one processor and communication ports. The processor (670) may include various modules associated with embodiments of the present disclosure.

In an embodiment, the communication port (660) may be any of an RS-232 port for use with a modem-based dialup connection, a 10/100 Ethernet port, a Gigabit or 10 Gigabit port using copper or fiber, a serial port, a parallel port, or other existing or future ports. The communication port (660) may be chosen depending on a network, such a Local Area Network (LAN), Wide Area Network (WAN), or any network to which the computer system (600) connects.

In an embodiment, the memory (630) may be a Random Access Memory (RAM), or any other dynamic storage device commonly known in the art. The read-only memory (640) may be any static storage device(s) e.g., but not limited to, a Programmable Read Only Memory (PROM) chips for storing static information e.g., start-up or Basic Input/Output system (BIOS) instructions for the processor (670).

In an embodiment, the mass storage device (650) may be any current or future mass storage solution, which can be used to store information and/or instructions. Exemplary mass storage solutions include, but are not limited to, Parallel Advanced Technology Attachment (PATA) or Serial Advanced Technology Attachment (SATA) hard disk drives or solid-state drives (internal or external, e.g., having Universal Serial Bus (USB) and/or Firewire interfaces), one or more optical discs, Redundant Array of Independent Disks (RAID) storage, e.g., an array of disks (e.g., SATA arrays).

In an embodiment, the bus (620) communicatively couples the processor(s) (670) with the other memory, storage, and communication blocks. The bus (620) may be, e.g., a Peripheral Component Interconnect (PCI)/PCI Extended (PCI-X) bus, Small Computer System Interface (SCSI), USB or the like, for connecting expansion cards, drives, and other subsystems as well as other buses, such a front side bus (FSB), which connects the processor (670) to computer system (600).

Optionally, operator and administrative interfaces, e.g., a display, keyboard, joystick, and a cursor control device, may also be coupled to the bus (620) to support direct operator interaction with the computer system (600). Other operator and administrative interfaces may be provided through network connections connected through the communication port (660). Components described above are meant only to exemplify various possibilities. In no way should the aforementioned exemplary computer system (600) limit the scope of the present disclosure.

While the foregoing describes various embodiments of the invention, other and further embodiments of the invention may be devised without departing from the basic scope thereof. The scope of the invention is determined by the claims that follow. The invention is not limited to the described embodiments, versions or examples, which are included to enable a person having ordinary skill in the art to make and use the invention when combined with information and knowledge available to the person having ordinary skill in the art.

### ADVANTAGES OF THE PRESENT DISCLOSURE

The present disclosure provides a system and a method to identify interference data in real-time and automatically mitigates the interference without human intervention.

The present disclosure enhances the network performance and provides a superior user experience.

The present disclosure provides a system and a method to resolve the interference caused by different Macros, eNodeB, etc. across different geographies with zero or near-zero human interference.

We claim:

1. A change engine system (104) for automatic interference mitigation in a network, comprising:
one or more processors (202); and
a memory operatively coupled to the one or more processors (202), wherein the memory comprises processor-executable instructions, which on execution, cause the one or more processors (202) to:
receive a plurality of change requests from a plurality of sources;
determine interference network cell data from the received plurality of change requests;
index and segment the determined interference network cell data across at least one of: a plurality of states and a plurality of network elements;
determine at least one change parameter of a plurality of change parameters based on the indexed and segmented interference network cell data;
determine at least one command of a plurality of commands based on the at least one determined change parameter; and
apply the at least one command on the plurality of network elements to automatically mitigate the interference in the network.

2. The change engine system (104) as claimed in claim 1, wherein the plurality of sources comprises at least one of: a Remote Electrical Tilt (RET), a Topographic Interference Mitigation (TIM), and an Automatic Telecommunications Operator (ATO).

3. The change engine system (104) as claimed in claim 1, wherein the plurality of change requests comprises information corresponding to at least one of: a plurality of cells, interference corresponding to the plurality of cells, and changes corresponding to the interference.

4. The change engine system (104) as claimed in claim 1, wherein the at least one command corresponds to a change in a configuration of at least one of: an antenna tilt, and a power attenuation.

5. The change engine system (104) as claimed in claim 1, wherein the one or more processors (202) are to determine the at least one command by being configured to:
determine a plurality of change commands based on the determined plurality of change parameters;
map each of the plurality of change commands with each of the plurality of change parameters, wherein the mapped information is stored in a database (210) associated with the change engine system (104); and
determine the at least one command based on the mapping.

6. The change engine system (104) as claimed in claim 1, wherein the plurality of commands is based on at least one of: a plurality of network element types, a plurality of software versions, and options related to logical change.

7. The change engine system (104) as claimed in claim 1, wherein the one or more processors (202) are to:
automatically detect a failure of the at least one command applied on the plurality of network elements in the network;
segregate the at least one failed command from successful commands based on the detection; and
automatically reapply the at least one failed command on the corresponding plurality of network elements.

8. The change engine system (104) as claimed in claim 7, wherein the one or more processors (202) are to:
determine whether a number of reapplying of the at least one failed command on the corresponding plurality of network elements exceeds a predefined threshold;
in response to a positive determination, ignore the reapplying of the at least one failed command on the plurality of network elements; and
in response to a negative determination, adjust the at least one failed command to be reapplied on the plurality of network elements.

9. The change engine system (104) as claimed in claim 7, wherein the one or more processors (202) are to generate, in real time, a report comprising at least one of: information of the at least one failed command and information of the successful commands.

10. The change engine system (104) as claimed in claim 1, wherein the one or more processors (202) are to predict the interference in the network based on the determined interference network cell data.

11. A method for automatic interference mitigation in a network, wherein the method comprises:
receiving, by one or more processors (202) associated with a change engine system (104), a plurality of change requests from a plurality of sources;
determining, by the one or more processors (202), interference network cell data from the received plurality of change requests;
indexing and segmenting, by the one or more processors (202), the determined interference network cell data across at least one of: a plurality of states and a plurality of network elements;
determining, by the one or more processors (202), at least one change parameter of a plurality of change parameters based on the indexed and segmented interference network cell data;
determining, by the one or more processors (202), at least one command of a plurality of commands based on the at least one determined change parameter; and
applying, by the one or more processors (202), the at least one command on the plurality of network elements to automatically mitigate the interference in the network.

12. The method as claimed in claim 11, wherein determining, by the one or more processors (202), the at least one command of the plurality of commands comprises:
determining, by the one or more processors (202), a plurality of change commands based on the determined plurality of change parameters;
mapping, by the one or more processors (202), each change command of the plurality of change commands with each of the plurality of change parameters, wherein the mapped information is stored in a database (210) associated with the change engine system (104); and
determining, by the one or more processors (202), the at least one command based on the mapping.

13. The method as claimed in claim 11, wherein the method comprises:
automatically detecting, by the one or more processors (202), a failure of the at least one command applied on the plurality of network elements in the network;
segregating, by the one or more processors (202), the at least one failed command from successful commands based on the detection; and
automatically reapplying, by the one or more processors (202), the at least one failed command on the corresponding plurality of network elements.

14. The method as claimed in claim 13, wherein the method comprises:
determining, by the one or more processors (202), whether a number of reapplying of the at least one failed command on the corresponding plurality of network elements exceeds a predefined threshold;
in response to a positive determination, ignoring, by the one or more processors (202), the reapplying of the at least one failed command on the plurality of network elements; and
in response to a negative determination, adjusting, by the one or more processors (202), the at least one failed command to be reapplied on the plurality of network elements.

15. The method as claimed in claim 13, wherein the method comprises generating, in real time, by the one or more processors (202), a report comprising at least one of: information of the at least one failed command and information of the successful commands.

16. A non-transitory computer-readable medium comprising processor-executable instructions that cause a processor to:
receive a plurality of change requests;
determine interference network cell data from the received plurality of change requests;
index and segment the determined interference network cell data across at least one of: a plurality of states and a plurality of network elements;
determine at least one change parameter of a plurality of change parameters based on the indexed and segmented interference network cell data;
determine at least one command of a plurality of commands based on the at least one determined change parameter; and
apply the at least one command on the plurality of network elements to automatically mitigate the interference in the network.
